(19) United States
(12) Patent Application Publication
(10) Pub. No.: US 2021/0101606 A1
(43) Pub. Date: Apr. 8, 2021

(54) NONAUTONOMOUS VEHICLE SPEED PREDICTION WITH AUTONOMOUS VEHICLE REFERENCE

(71) Applicant: Ford Global Technologies, LLC, Dearborn, MI (US)

(72) Inventors: Linjun Zhang, Canton, MI (US); Helen Elizabeth Kourous-Harrigan, Monroe, MI (US)

(73) Assignee: Ford Global Technologies, LLC, Dearborn, MI (US)

(21) Appl. No.: 16/594,216

(22) Filed: Oct. 7, 2019

(51) Int. Cl. B60W 40/107; B60W 40/105; H04W 4/44

(52) U.S. Cl. CPC B60W 40/107; B60W 40/105; B60W 2550/40; B60W 2550/30; B60W 2750/30; H04W 4/44

(57) ABSTRACT

Respective planned reference velocities of a reference vehicle are received for each of a plurality of time steps including a current time step. Respective sensed velocities of a subject vehicle for each of the time steps are determined from sensor data. Respective distances between the reference vehicle and the subject vehicle are determined for each of the plurality of time steps. A number of intervening vehicles between the reference vehicle and the subject vehicle is determined. Based on the planned reference velocities of the reference vehicle, the sensed velocities of the subject vehicle, the distance, and the number of intervening vehicles, a future velocity of the subject vehicle is predicted at a time step that is after the current time step.

### BACKGROUND

The Society of Automotive Engineers (SAE) has defined multiple levels of vehicle automation. At levels 0-2, a human driver monitors or controls the majority of the driving tasks, often with no help from the vehicle. For example, at level 0 (“no automation”), a human driver is responsible for all vehicle operations. At level 1 (“driver assistance”), the vehicle sometimes assists with steering, acceleration, or braking, but the driver is still responsible for the vast majority of the vehicle control. At level 2 (“partial automation”), the vehicle can control steering, acceleration, and braking under certain circumstances with human supervision but without direct human interaction. At levels 3-5, the vehicle assumes more driving-related tasks. At level 3 (“conditional automation”), the vehicle can handle steering, acceleration, and braking under certain circumstances, as well as monitoring of the driving environment. Level 3 requires the driver to intervene occasionally, however. At level 4 (“high automation”), the vehicle can handle the same tasks as at level 3 but without relying on the driver to intervene in certain driving modes. At level 5 (“full automation”), the vehicle can handle almost all tasks without any driver intervention.

Vehicle-to-infrastructure (V2I) and vehicle-to-vehicle (V2V) communications can allow for vehicles at various levels of automation to provide each other and/or infrastructure elements with data. For example, the infrastructure element may be able to provide data about objects, hazards, etc., in the area to support a vehicle's path planning, e.g., avoidance of hazards and objects, and/or vehicles may be able to provide each other with such data.

### BRIEF DESCRIPTION OF THE DRAWINGS

FIG. 1 is a block diagram illustrating an example traffic communications and control system.

FIG. 2 is a diagram illustrating an example traffic scene in which the system of FIG. 1 could be implemented.

FIG. 3 is a flowchart of an exemplary process for predicting velocity of a subject vehicle.

FIG. 4 shows an example graph of empirical data from which thresholds for a minimum and maximum number of time steps can be determined.

### DESCRIPTION

### Overview

A computer includes a processor and a memory, the memory storing instructions executable by the processor to receive respective planned reference velocities of a reference vehicle for each of a plurality of time steps including a current time step; determine, from sensor data, respective sensed velocities of a subject vehicle for each of the time steps; determine respective distances between the reference vehicle and the subject vehicle for each of the plurality of time steps; determine a number of intervening vehicles between the reference vehicle and the subject vehicle; and based on the planned reference velocities of the reference vehicle, the sensed velocities of the subject vehicle, the distance, and the number of intervening vehicles, predict a future velocity of the subject vehicle at a time step that is after the current time step.

The reference vehicle can be an autonomous vehicle and the subject vehicle can be a non-autonomous or semi-autonomous vehicle, wherein a reference vehicle computer controls velocity of the reference vehicle and a human operator controls velocity of the subject vehicle.

The computer can be mounted to a stationary infrastructure element. The computer can further including instructions to predict the future velocity only upon determining that the plurality of time steps for which sensed velocities on the subject vehicle have been determined exceeds a predetermined threshold number of time steps. The computer can further including instructions to determine an accumulated delay for adjusting a velocity in the reference vehicle, wherein the accumulated delay is a number of time steps based on the number of intervening vehicles between the reference vehicle and the subject vehicle. The can further including instructions to predict the future velocity according to a kernel vector dimensioned based on the accumulated delay. The kernel vector can include the planned velocities of the reference vehicle, the sensed velocities of the subject vehicle, and the distances between the reference vehicle and the subject vehicle. The computer can further including instructions to predict the future velocity according to a kernel vector further including instructions to multiply the kernel vector by a weight vector to obtain the predicted future velocity. The weight vector can be determined at least in part by recursively incorporating a weight vector for a prior time step. The weight vector can be determined at least in part based on a kernel vector for a prior time step. The weight vector can be determined in part according to an adjustment factor that diminishes weight given to prior time steps. The can further including instructions to determine the accumulated delay for adjusting a velocity in the reference vehicle based additionally on a specified maximum possible delay. The future velocity can be one of a plurality of future velocities; the instructions can further including instructions to determine the future velocities for each of a specified number of future time steps. The computer can further including instructions to predict the future velocity of the subject vehicle based on one or more constraints. The one or more constraints can include at least one of a distance constraint, a velocity constraint, and an acceleration constraint.

A method, comprised receiving respective planned reference velocities of a reference vehicle for each of a plurality of time steps including a current time step; determining, from sensor data, respective sensed velocities of a subject vehicle for each of the time steps; determining respective distances between the reference vehicle and the subject vehicle for each of the plurality of time steps; determining a number of intervening vehicles between the reference vehicle and the subject vehicle; and based on the planned reference velocities of the reference vehicle, the sensed velocities of the subject vehicle, the distance, and the number of intervening vehicles, predicting a future velocity of the subject vehicle at a time step that is after the current time step.

The reference vehicle can be an autonomous vehicle and the subject vehicle can be a non-autonomous or semi-autonomous vehicle, wherein a reference vehicle computer controls velocity of the reference vehicle and a human operator controls velocity of the subject vehicle. The method can further comprise determining an accumulated delay for adjusting a velocity in the reference vehicle, wherein the accumulated delay is a number of time steps based on the number of intervening vehicles between the reference vehicle and the subject vehicle. The method can further comprise predicting the future velocity according to a kernel vector dimensioned based on the accumulated delay, wherein the kernel vector includes the planned velocities of the reference vehicle, the sensed velocities of the subject vehicle, and the distances between the reference vehicle and the subject vehicle. The method can further comprise predicting the future velocity according to a kernel vector further including instructions to multiply the kernel vector by a weight vector to obtain the predicted future velocity.

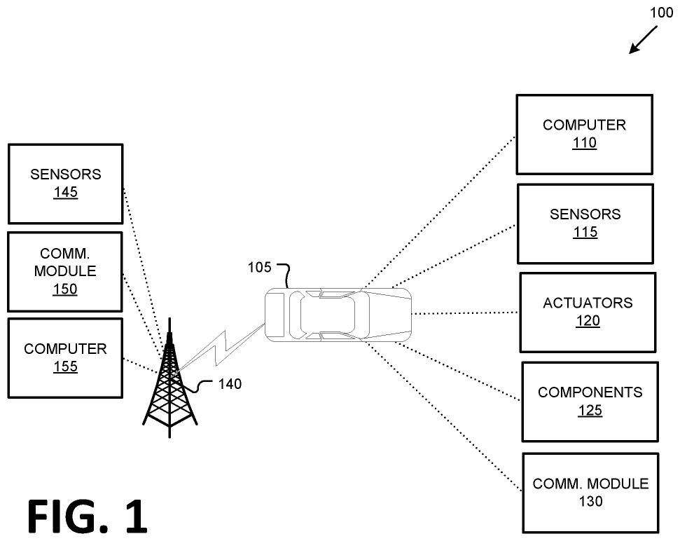

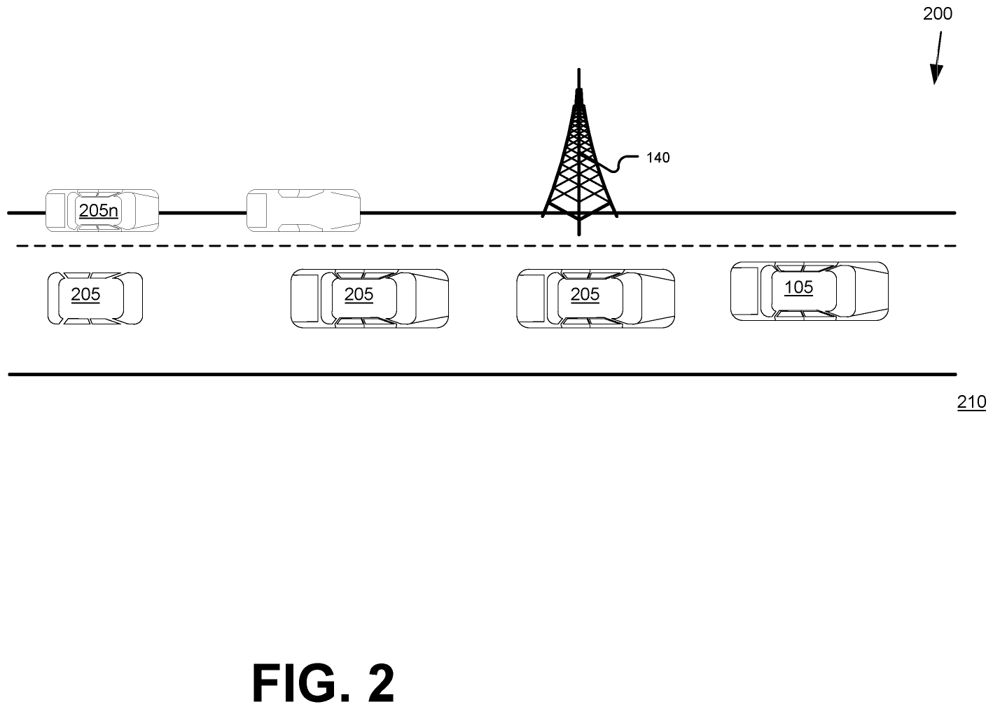

With reference to FIGS. 1 and 2, a traffic communications and control system 100 includes an infrastructure element 140 provided to monitor a defined area 200 around the infrastructure element 140, including vehicles 105, 205 in the area 200. For example, the defined area 200 could be an area that is proximate to the infrastructure element 140. In the present context, “proximate” means that the area 200 is defined by a field of view of one or more element 140 sensors 145. The defined area 200 could alternatively be an area defined by a radius around the element 140 or some other distance or set of distances relative to the infrastructure element 140.

The vehicle 105 is capable of fully autonomous operation (as further defined below), i.e., typically at SAE level 4 or level 5 with a vehicle computer 110 controlling each of vehicle 105 steering, propulsion, and braking. The autonomous vehicle 105 follows a trajectory planned by the computer 110. The planned trajectory includes respective sets of points that the vehicle 105 is planned to traverse at respective future times, along with planned speeds or velocities (those terms being used interchangeably herein to denote an instantaneous rate of motion of the vehicle 105 along a longitudinal axis) for the vehicle 105 at the respective future times. Vehicles 205, on the other hand, are operated non-autonomously or semi-autonomously, i.e., with a human operator controlling propulsion and braking, i.e., speed, acceleration, and deceleration, of the vehicle 205. Thus, a non-autonomous vehicle 205 follows a trajectory determined by input, including to accelerator and/or brake pedals, by a human operator.

In contrast to predicted or planned future speeds of the autonomous vehicle 105, which can be provided by the computer 110, it is a problem to predict future speeds of the non-autonomous vehicle 205. Advantageously, as disclosed herein, a future speed or speeds of a non-autonomous vehicle 205 can be predicted based on detected speeds of the vehicle 205 along with planned speeds of the autonomous vehicle 105.

### Exemplary System

### Vehicle

A vehicle 105 typically (but not necessarily) is a land vehicle such as a car, truck, etc. Additionally or alternatively, a vehicle 105 may include a bicycle, a motorcycle, etc. A vehicle 105 includes a vehicle computer 110, sensors 115, actuators 120 to actuate various vehicle components 125, and a vehicle communications module 130. The communications module 130 allows the vehicle computer 110 to communicate with one or more infrastructure elements 140 and a central server 170, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

A vehicle computer 110 includes a processor and a memory such as are known. The memory includes one or more forms of computer-readable media, and stores instructions executable by the computer 110 for performing various operations, including as disclosed herein.

The computer 110 may operate a vehicle 105 in an autonomous, a semi-autonomous mode, or a non-autonomous (or manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 105 network such as a communications bus as described further below, more than one processor, e.g., included in electronic controller units (ECUs) or the like included in the vehicle for monitoring and/or controlling various vehicle components 125, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle 105 network, the computer 110 may transmit messages to various devices in the vehicle and/or receive messages (e.g., CAN messages) from the various devices, e.g., sensors 115, an actuator 120, an human machine interface (HMI), etc. Alternatively or additionally, in cases where the computer 110 actually comprises a plurality of devices, the vehicle 105 communication network may be used for communications between devices represented as the computer 110 in this disclosure. Further, as mentioned below, various controllers and/or sensors 115 may provide data to the computer 110 via the vehicle communication network.

Vehicle 105 sensors 115 may include a variety of devices such as are known to provide data to the computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles 105, etc., relative to the location of the vehicle 105. The sensors 115 may further alternatively or additionally, for example, include camera sensor(s) 115, e.g. front view, side view, etc., providing images from an area surrounding the vehicle 105. In the context of this disclosure, an object is a physical, i.e., material, item that can be represented by physical phenomena (e.g., light or other electromagnetic waves, or sound, etc.) detectable by sensors 115. Thus, vehicles 105, as well as other items including as discussed below, fall within the definition of “object” herein.

The vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 101, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications (cellular and/or DSRC., etc.) to another vehicle—to an infrastructure element 140 (typically via direct radio frequency communications) and/or (typically via the network 135) a remote server 170. The module 130 could include one or more mechanisms by which the computers 110 of vehicles 105 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 can include cellular, Bluetooth, IEEE 802.11, dedicated short range communications (DSRC), cellular V2X (CV2X), and the like.

### Network

The vehicle 105 and infrastructure element 140 can communicate with one another and/or other devices via one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, Dedicated Short Range Communications (DSRC), Cellular Vehicle-to-Everything Communication (CV2x) etc.), local area networks (LAN) and/or wide area networks (WAN), including the Internet, providing data communication services.

### Infrastructure Element

An infrastructure element 140 includes a physical structure such as a tower or other support structure (e.g., a pole, a box mountable to a bridge support, cell phone tower, road sign support, etc.) on or in which infrastructure sensors 145, as well as an infrastructure communications module 150 and computer 155 can be housed, mounted, stored, and/or contained, and powered, etc. One infrastructure element 140 is shown in FIG. 1 for ease of illustration, but the system 100 could and likely would include tens, hundreds, or thousands of elements 140.

An infrastructure element 140 is typically stationary, i.e., fixed to and not able to move from a specific physical location. The infrastructure sensors 145 may include one or more sensors such as described above for the vehicle 105 sensors 115, e.g., LIDAR, radar, cameras, ultrasonic sensors, etc. The infrastructure sensors 145 are fixed or stationary. That is, each sensor 145 is mounted to the infrastructure element so as to have a substantially unmoving and unchanging field of view. For convenience, “infrastructure” may be abbreviated to “IX.”

Sensors 145 thus provide field of views in contrast to vehicle 105 sensors 115 in a number of advantageous respects. First, because sensors 145 have a substantially constant field of view, determinations of vehicle 105 and object locations can be accomplished with fewer and simpler processing resources than if movement of the sensors 145 also had to be accounted for. Further, the sensors 145 include an external perspective of the vehicle 105 and can sometimes detect features and characteristics of objects not in the vehicle 105 sensors 115 field(s) of view and/or can provide more accurate detection, e.g., with respect to vehicle 105 location and/or movement with respect to other objects. Yet further, sensors 145 can communicate with the element 140 computer 155 via a wired connection, whereas vehicles 105 typically can communicates with elements 140 and/or a server 170 only wirelessly, or only at very limited times when a wired connection is available. Wired communications are more reliable and can be faster than wireless communications such as vehicle-to-infrastructure communications or the like.

The communications module 150 and computer 155 typically have features in common with the vehicle computer 110 and vehicle communications module 130, and therefore will not be described further to avoid redundancy. Although not shown for ease of illustration, the infrastructure element 140 also includes a power source such as a battery, solar power cells, and/or a connection to a power grid.

### Example Environment

FIG. 2 illustrates an example traffic area 200 monitored by an infrastructure element 140. The traffic area 200 includes vehicles 105, 205 on a road 210. As discussed further below, an autonomous vehicle 105 can provide its planned speeds at future times to the infrastructure element 140 (i.e., a computer 110 via a communications module 130 can provide such data to a computer 155 via a communication module 150). Further, an infrastructure 140 computer 155 can receive sensor 145 data detecting respective speeds of vehicles 205 at respective times. To predict a future speed or speeds of a nonautonomous vehicle 205n (referred to herein for convenience as a “subject” vehicle, i.e., the vehicle 205n who speed a computer 155 is predicting), a computer 155 can identify a closest autonomous vehicle 105, i.e., a closest vehicle 105 ahead of the non-autonomous vehicle 205n in a same lane of a road 210 as the vehicle 205n, e.g., a basic safety message (BSM) from a vehicle 105 to the infrastructure 140 can identify a vehicle 105 location; the infrastructure computer 155 can then project the vehicle 105 location onto a digital map maintained by the computer 155 of the area 200. Note that other vehicles 205 may be between the subject vehicle 205n and the closest autonomous vehicle 105 (sometimes referred to for convenience as the “reference” vehicle 105) in the same lane. By using the planned future speeds of the reference vehicle 105 and the detected speeds of the vehicle 205n, a computer 155 can predict future speeds of the vehicle 205n.

In an exemplary implementation, the computer 155 can receive respective planned reference velocities of a reference vehicle 105 for each of a plurality of time steps including a current time step. A time step is a moment in time defined by an amount of time the lapsing since a last time step, e.g., specified according to an amount of time between sampling sensor data and/or data received from a vehicle 105. For example, in one implementation, time steps are 100 milliseconds apart, which is a typical amount of time between time steps for data reported via V2X communications. The computer 105 can further determine, from sensor 145 data, respective sensed velocities of a subject vehicle 205n for each of the time steps. Further, typically based on sensor 145 data, the computer 155 can determine respective distances between the reference vehicle 105 and the subject vehicle 205n for (i.e., at) each of the plurality of time steps. The computer 155 can also determine a number of intervening vehicles 205 between the reference vehicle 105 and the subject vehicle 205n. Then, based on the planned reference velocities of the reference vehicle, the sensed velocities of the subject vehicle, the distance, and the number of intervening vehicles, the computer 155 can predict a future velocity of the subject vehicle at a time step that is after the current time step.

The following definitions are useful to further explain predicting subject vehicle 205n speeds.

TABLE 1

| | |
|---|---|
| vₙ[tₖ] | Velocity of an n^{th} vehicle at a k^{th} time step t. |
| x[tₖ] | Kernel vector including velocities and distances |
| | from a reference vehicle of an n^{th} |
| | vehicle at a k^{th} time step t. |
| Vₘ[tₖ] | Velocity of a reference vehicle m at a k^{th} time step t. |
| hₘₙ[tk] | Distance between a reference vehicle m |
| | and a vehicle n at a k^{th} time step t. |
| Δt | A data sampling time, i.e., a time between |
| | sensor data samples, and also an amount of |
| | time between respective time steps t₀ . . . tₓ₋₁, tₖ, tₖ₊₁ . . . |
| τ | Represents a maximum human reaction delay |
| | time from a current time k to change a |
| | velocity of a vehicle upon a change in velocity |
| | of an immediately preceding (i.e., next |
| | forward) vehicle; in one example, based on |
| | research suggesting that a maximum |
| | reaction time is 3 seconds, T = 3. |
| d | A number of delay steps for a human driver from |
| | a current time k to change a velocity of |
| | a vehicle upon a change in velocity of an |
| | immediately preceding (i.e., next forward) |
| | vehicle; can be determined as d = T/Δt. |
| Dₙ | A number of delay steps (sometimes referred |
| | to as the accumulated delay) for a vehicle |
| | n to change a velocity based on a change of |
| | velocity in a reference vehicle m, given by |
| | Dₙ = Md, where M is a number of vehicles |
| | between the vehicle n and a reference vehicle |
| | m. |
| w^{T} | Linear expansion of a weight vector w. |
| S | A minimum number of time steps for which |
| | data samples for a reference vehicle to be |
| | provided before outputting a predicted |
| | velocity vₙ[tₖ₊₁] for the reference vehicle. |
| N | A maximum number of timesteps for which |
| | data samples for a reference vehicle will be |
| | provided before no longer outputting a |
| | predicted velocity vₙ[tₖ₊₁] the reference |
| | vehicle. |

The computer 155 can be programmed to model future velocities of a subject vehicle 205n with a model in linear form as shown in Equation (1):

vₙ[tₖ₊₁]=w^{T}x[tₖ] (1)

The kernel vector x can model various vehicle states for a number of time steps takes into account the delay Dₙ for a human operator of the subject vehicle 205n to react, i.e., to adjust a speed of the vehicle 205n, after a speed of the reference vehicle 105 is changed. The accumulated delay Dₙ (in examples below Dₙ may be abbreviated to D), i.e., is a number of time steps determined based on the number of intervening vehicles 205 between the reference vehicle 105 and the subject vehicle 205n, can be determined according to the definitions in Table 1. The kernel vector the kernel vector can be dimensioned based on the accumulated delay Dₙ, e.g., the kernel vector can model three vehicle 105, 205n states for D+1 time steps, i.e., the kernel vector can be a matrix having dimensions of three by D+1. The size of D+1 is chosen in the present example implementation because it means that the accumulated delay taken into account is the maximum delay τ multiplied by the number of intervening vehicles 205 between the reference vehicle 105 and the subject vehicle 205n (plus one row or column to account for the fact that τ has been discretized), i.e., a human operator of the vehicle 205n is assumed to be reacting to a change in velocity of the reference vehicle 105 that occurred approximately τ seconds ago, i.e., τ seconds prior to a current time step k. In the present example, the three vehicle 105, 205, states are reference vehicle 105 velocities vₘ[t_{k-D-1}], . . . , vₘ[tₖ₋₁], distances between the reference vehicle 105 and the subject vehicle 205n hₘₙ[t_{k-D-1}], . . . , hₘₙ[tₖ₋₁], and detected velocities of the subject vehicle 205n vₙ [t_{k-D-1}], . . . , vₙ[tₖ₋₁].

The vector x can be provided in any suitable form, e.g., polynomial, exponential, sinusoidal, etc., and in the present example is represented in linear form:

x[tₖ]=[vₘ[t_{k-D-1}], . . . ,vₘ[tₖ₋₁],hₘₙ[t_{k-D-1}, . . . ,hₘₙ[tₖ₋₁],vₙ[t_{k-D-1}], . . . ,vₙ[tₖ₋₁]]^{T} (2)

Once the kernel vector x is determined, it is then possible to estimate the weight vector w. The weight vector w for a time step can be determined at least in part recursively by incorporating one or more weight vectors from respective prior time steps. The weight vector w for a time step can be determined at least in part based on one or more kernel vectors from respective prior time steps. Yet further, the weight vector can be determined in part according to an adjustment factor that diminishes weight given to prior time steps. Thus, the weight vector can be determined by

w[tₖ]=w[tₖ₋₁]+αg (3)

The factor α combines a current velocity of the subject vehicle 205n with the weighted kernel matrix for the immediately prior time step k−1 to the current time step k as follows:

α=vₙ[tₖ]−w^{T}x[tₖ₋₁] (4)

The factor g is recursively determined:

$$g = \frac{Px [ {t}_{k - 1} ]}{λ + {x}^{T} [ {t}_{k - 1} ] Px [ {t}_{k - 1} ]} \qquad ( 5 )$$

where a covariance matrix P is a large (i.e., typically over 10,000 rows) diagonal matrix, initialized as an identity matrix, and then recursively determined as follows:

$$P = \frac{P - g {x}^{T} [ {t}_{k - 1} ] P}{λ} \qquad ( 6 )$$

where in both equations (5) and (6) λ is a “forgetting factor,” i.e., a value provided to give less weight to data from successively older time steps. In one example, λ=0.997. A value for λ can be determined empirically, e.g., by trial and error. That is, comparing measured, and therefore assumed to be true, value of a vehicle 205 velocity with respective values for vₙ [tₖ₊₁] as described herein at time steps corresponding to the measured value using various values of λ, can yield an appropriate value for λ. For example, if is λ too small, oscillations and unpredictability in vₙ[tₖ₊₁] will result. On the other hand, overly large values for λ will unduly reduce the weight given to newly acquired data.

### Processes

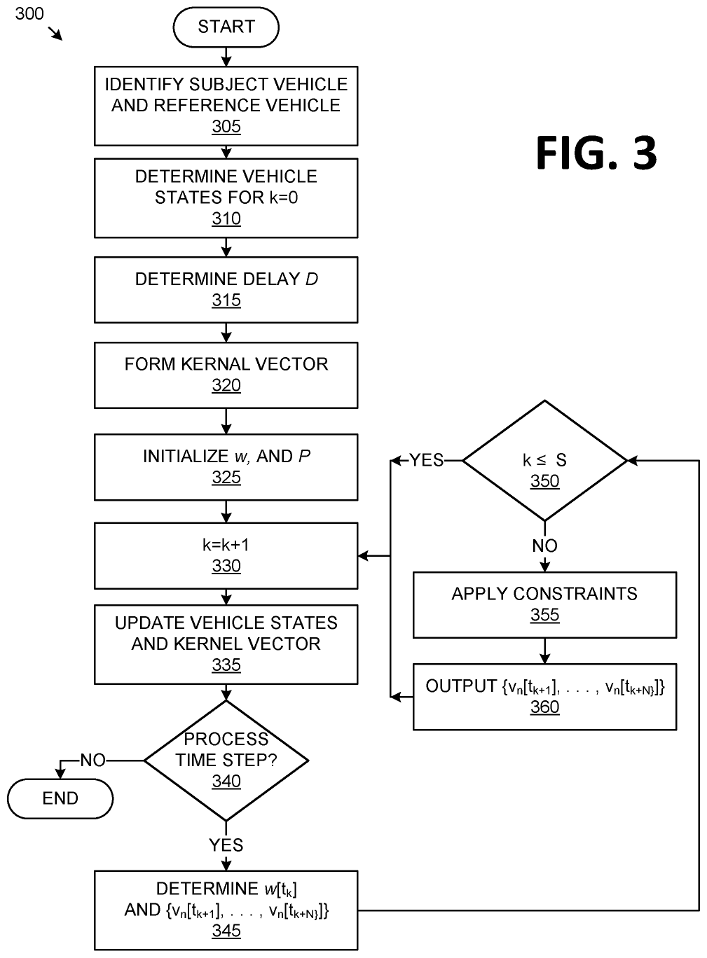

FIG. 3 is a flowchart of an exemplary process 300 to predict a future velocity (and typically a set of future velocities for respective time steps) of a subject vehicle 205. The process 300 can be carried out by an infrastructure 140 computer 155 processor executing instructions stored in the computer 155 memory. Note, however, that although description herein focuses on determining subject vehicle 205 velocities in an infrastructure 140 computer 155, in principle processing to determine subject vehicle 205 velocities could be executed in some other computer, e.g., a vehicle 105 computer 110, based on obtaining data as described herein. It is also to be noted that the process 300 describes predicting future velocities of a single subject vehicle 205n with respect to a reference vehicle 105. However, in practice, the computer 155 could substantially simultaneously predict velocities of multiple subject vehicles 205, possibly respect to two or more different reference vehicles 105.

The process 300 begins in a block 305, in which the computer 155 identifies a reference vehicle 105 and a subject vehicle 205. For example, the computer 155 can identify vehicles 105, 205 by interpreting data from sensors 145, e.g., according to known techniques for interpreting data from lidar, cameras, etc., to localize and classify objects. Further, the reference vehicle 105, which is capable of autonomous operation as described above, is typically identified according to V2X communications such as described above. That is, the vehicle 105 can broadcast a message received by an infrastructure element 140 identifying the vehicle 105 in providing other data, such as a location (i.e., according to a specified coordinate system), a current speed and/or heading, and planned speeds and/or headings for respective time steps (i.e., future trajectory data), etc. Thus, the process 300 can begin when the computer 155 identifies a reference vehicle 105 and then determines a presence of a subject vehicle 205 (and often, as noted above, a plurality of subject vehicles 205) for which velocities can be predicted.

Next, in a block 310, the computer 155 determines state data for the subject vehicle 205 for an initial time step k=0. State data typically includes a vehicle 205n speed and location. Alternatively or additionally, the state data could include the vehicle 205n speed and distance from the reference vehicle 105. The distance from the reference vehicle 105 can be a linear distance (e.g., measured in meters or the like) and/or a number of other vehicles 205 between the subject vehicle 205n and the reference vehicle 105. Further, state data for the reference vehicle 105 for a current time step can be provided in a message from the vehicle 105 as described above.

Next, in a block 315, the computer 155 determines the delay Dₙ, which can be determined as described above.

Next, in a block 320, the computer 155 forms the kernel vector x described above, i.e., including velocities of vehicles 105, 205n, and a distance between them, for the initial time step k=0.

Next, in a block 325, the computer 155 initializes values for the weight vector w and the covariance vector P, for the initial time step k=0.

Next, in a block 330, the computer 155 increments the time step k to a next time step k, i.e., sets k=k+1.

Next, in a block 335, the computer 155, based on sensor 145 data and/or data from a vehicle 105, updates vehicle 105, 205n state data, including velocities and locations of vehicles 105, 205, for the current time step k. Further, the kernel vector x, each includes vehicle 105, 205n state data as described above, can be updated with this state data for the current time step k.

Next, in a decision block 340, the computer 155 determines whether to process the current time step k, i.e., whether the process 300 should continue to predict the velocity of the subject vehicle 205n. For example, the computer 155 could determine not to continue to predict the velocity of the subject vehicle 205 upon determining that the subject vehicle 205n and/or the reference vehicle 105 has left the area 200, i.e., is no longer within a field of view and/or a specified distance of infrastructure element 140. If it is determined that the process 300 should not continue, i.e., that the current time step k should not be processed, then the process 300 ends. Otherwise, the process 300 proceeds to a block 345.

In the block 345, the computer 155 determines values for the weight vector w [tₖ] for the current time step k, and then predicts a velocity vₙ[tₖ₊₁] for the vehicle 205n for a next time step k+1, e.g., according to the equations provided above. Thus, in repeated iterations of the block 345, the computer 155 accumulates a set of predicted velocities, up to a number of timesteps determined by the prediction horizon N, i.e., a set of predicted velocities {vₙ[tₖ₊₁], . . . {vₙ[t_{k+N}]}.

Next, in a decision block 350, the computer 155 determines whether a threshold number of time steps has been exceeded, i.e., the threshold S described above in Table 1, and typically also determines whether the current time step is within, e.g., less than or equal to, the established horizon N for providing predicted velocities for the reference vehicle 205n. That is, the computer 155 is typically programmed to output a future velocity only upon determining that the plurality of time steps for which sensed velocities on the subject vehicle 205n have been determined exceeds a predetermined threshold number of time steps.

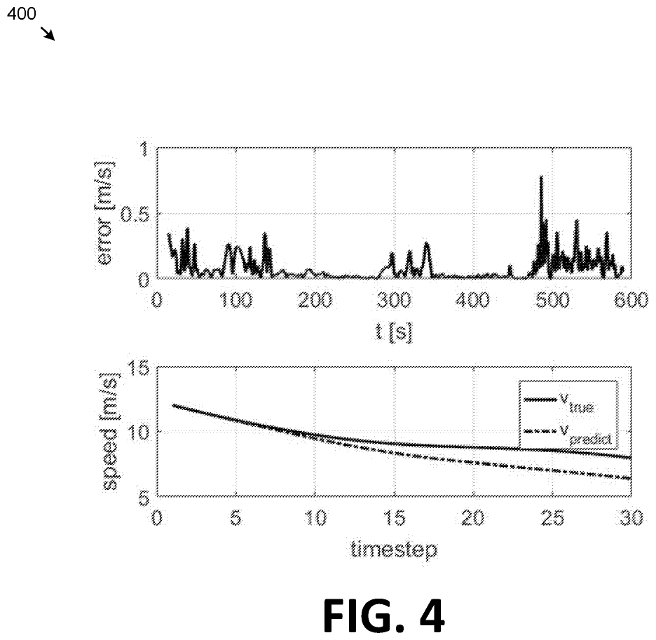

The threshold number of time steps S and the prediction horizon N are determined according to a range of time steps within which the velocity prediction is likely to be reliable. That is, in general, too few time steps means not enough data for a reliable prediction, and too many time steps means a prediction is too far in the future to be reliable. These numbers of time steps can be determined by empirical testing, i.e., by operating vehicles 105, 205n on a test track or some other test environment and evaluating accuracy of predicted velocities against actual measured velocities of a vehicle 205n. FIG. 4 shows an example of empirical data where S=150 and N=30. The top graph in FIG. 4 shows error of accuracy of predicted velocities against actual measured velocities of a vehicle 205n in m/s or meters (vertical axis) over time in seconds (horizontal axis). The bottom graph in FIG. 4 shows predicted velocities against actual measured velocities of a vehicle 205n (speeds on the vertical axis) over time steps that are 100 ms apart, the time step 0 being at t=485.6 [s] shown in the top graph. As can be seen, error in predicting the reference vehicle 205n velocity was relatively low for these time steps, until, when the prediction horizon gets to a time step 30 (N=30), the error increases. Therefore, from this example data set, S could be set to 150, and N could be set to 30.

If the number of time steps, i.e., the current value of k, is less than or equal to S, then the process 300 returns to the block 330 from the block 350. Otherwise, the process 300 proceeds to a block 355.

In the block 355, the computer 155 applies one or more constraints to the value for predicted subject vehicle 205n velocity vₙ[tₖ₊₁] determined in the block 345. The one or more constraints can include at least one of a distance constraint, a velocity constraint, and an acceleration constraint. Expressions (7), (8), and (9) respectively illustrate an example distance constraint, velocity constraint and acceleration constraint:

$${v}_{n} [ {t}_{k + i} ] \leq {v}_{m} [ {t}_{k + i - 1} ] + \frac{( {h}_{m n} [ {t}_{k + i - 1} ] - {h}_{min} )}{dt} \qquad ( 7 )$$

where hₘᵢₙ denotes a minimum permissible distance between vehicles 105, 205;

vₘᵢₙ≤vₙ[tₖ₊ᵢ]≤vₘₐₓ (8)

vₙ[tₖ₊ᵢ₋₁]+aₘᵢₙdt≤vₙ[tₖ₊ᵢ]≤vₙ[tₖ₊ᵢ₋₁]+aₘₐₓdt (9)

The value hₘᵢₙ can be empirically determined. For example, an infrastructure 140 computer 155 could collect and store distances between vehicles 105, 205 stopping in the area 200 proximate to the infrastructure 140, e.g., near an intersection. These values could be averaged (or otherwise statistically analyzed) and rounded to an appropriate level of precision, e.g., 0.1 meter.

Next, in a block 360, constraints having been applied as described above in the block 355, the computer 155 outputs predicted subject vehicle 205n velocity vₙ[tₖ₊₁], and possible the set of velocities {vₙ [tₖ₊₁], . . . {vₙ[t_{k+N}]}, described above. Predicted subject vehicle 205n velocities for each time step can be stored, so that for up to the horizon or limit N of number of time steps to be predicted, a set of predicted subject vehicle 205n velocities vₙ[tₖ₊₁], . . . , vₙ[t_{k+N}] can be stored and output in the block 360. That is, a predicted future velocity for the reference vehicle 205n or a current time step can be one of a plurality of future velocities, each for one of a specified number (E.g., N-S) of future time steps. Following the block 360, the process 300 returns to the block 330.

### CONCLUSION

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

“Based on” encompasses “based wholly or partly on.” If, herein, a first thing is described and/or claimed as being “based on” the second thing, then the first thing is derived or calculated from the second thing, and/or output from an algorithm, process, or program function that accepts some or all of the second thing as input and outputs some or all of the first thing.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
receive respective planned reference velocities of a reference vehicle for each of a plurality of time steps including a current time step;
determine, from sensor data, respective sensed velocities of a subject vehicle for each of the time steps;
determine respective distances between the reference vehicle and the subject vehicle for each of the plurality of time steps;
determine a number of intervening vehicles between the reference vehicle and the subject vehicle; and
based on the planned reference velocities of the reference vehicle, the sensed velocities of the subject vehicle, the distance, and the number of intervening vehicles, predict a future velocity of the subject vehicle at a time step that is after the current time step.

2. The computer of claim 1, wherein the reference vehicle is an autonomous vehicle and the subject vehicle is a non-autonomous or semi-autonomous vehicle, wherein a reference vehicle computer controls velocity of the reference vehicle and a human operator controls velocity of the subject vehicle.

3. The computer of claim 1, wherein the computer is mounted to a stationary infrastructure element.

4. The computer of claim 1, the instructions further including instructions to predict the future velocity only upon determining that the plurality of time steps for which sensed velocities on the subject vehicle have been determined exceeds a predetermined threshold number of time steps.

5. The computer of claim 1, the instructions further including instructions to determine an accumulated delay for adjusting a velocity in the reference vehicle, wherein the accumulated delay is a number of time steps based on the number of intervening vehicles between the reference vehicle and the subject vehicle.

6. The computer of claim 5, the instructions further including instructions to predict the future velocity according to a kernel vector dimensioned based on the accumulated delay.

7. The computer of claim 6, wherein the kernel vector includes the planned velocities of the reference vehicle, the sensed velocities of the subject vehicle, and the distances between the reference vehicle and the subject vehicle.

8. The computer of claim 7, the instructions further including instructions to predict the future velocity according to a kernel vector further including instructions to multiply the kernel vector by a weight vector to obtain the predicted future velocity.

9. The computer of claim 8, wherein the weight vector is determined at least in part by recursively incorporating a weight vector for a prior time step.

10. The computer of claim 8, wherein the weight vector is determined at least in part based on a kernel vector for a prior time step.

11. The computer of claim 8, wherein the weight vector is determined in part according to an adjustment factor that diminishes weight given to prior time steps.

12. The computer of claim 5, the instructions further including instructions to determine the accumulated delay for adjusting a velocity in the reference vehicle based additionally on a specified maximum possible delay.

13. The computer of claim 1, wherein the future velocity is one of a plurality of future velocities, the instructions further including instructions to determine the future velocities for each of a specified number of future time steps.

14. The computer of claim 1, the instructions further including instructions to predict the future velocity of the subject vehicle based on one or more constraints.

15. The computer of claim 15, wherein the one or more constraints include at least one of a distance constraint, a velocity constraint, and an acceleration constraint.

16. A method, comprising:
receiving respective planned reference velocities of a reference vehicle for each of a plurality of time steps including a current time step;
determining, from sensor data, respective sensed velocities of a subject vehicle for each of the time steps;
determining respective distances between the reference vehicle and the subject vehicle for each of the plurality of time steps;
determining a number of intervening vehicles between the reference vehicle and the subject vehicle; and
based on the planned reference velocities of the reference vehicle, the sensed velocities of the subject vehicle, the distance, and the number of intervening vehicles, predicting a future velocity of the subject vehicle at a time step that is after the current time step.

17. The method of claim 16, wherein the reference vehicle is an autonomous vehicle and the subject vehicle is a non-autonomous or semi-autonomous vehicle, wherein a reference vehicle computer controls velocity of the reference vehicle and a human operator controls velocity of the subject vehicle.

18. The method of claim 16, further comprising determining an accumulated delay for adjusting a velocity in the reference vehicle, wherein the accumulated delay is a number of time steps based on the number of intervening vehicles between the reference vehicle and the subject vehicle.

19. The method of claim 18, further comprising predicting the future velocity according to a kernel vector dimensioned based on the accumulated delay, wherein the kernel vector includes the planned velocities of the reference vehicle, the sensed velocities of the subject vehicle, and the distances between the reference vehicle and the subject vehicle.

20. The method of claim 19, further comprising predicting the future velocity according to a kernel vector further including instructions to multiply the kernel vector by a weight vector to obtain the predicted future velocity.
